(19) United States
(12) Patent Application Publication
(10) Pub. No.: US 2010/0217435 A1
(43) Pub. Date: Aug. 26, 2010

(54) AUDIO SIGNAL PROCESSING SYSTEM AND AUTONOMOUS ROBOT HAVING SUCH SYSTEM

(75) Inventor: Tobias RODEMANN, Offenbach (DE)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Research Institute Europe GMBH, Offenbach/Main (DE)

(21) Appl. No.: 12/613,987

(22) Filed: Nov. 6, 2009

(30) Foreign Application Priority Data
Feb. 26, 2009 (EP) 09 153 712.6

(51) Int. Cl. G06F 19/00; G10L 19/00

(52) U.S. Cl. 700/245; 704/503; 704/E19.001

(57) ABSTRACT

An audio signal processing system includes one or more sensors for sensing audio signals. A module for computing audio signal segments of coherent signal elements, and at least one compressing module for computing a compressed representation of audio features of each audio signal segment are also included. The system also has a module for storing audio proto objects, which are data objects comprising the compressed representation and time information of the associated audio signal segment.

### FIELD OF INVENTION

The present invention relates to a system that is provided with audio signal sensing means and which processes the sensed audio signals to modify its behavior. Audio signals are transformed through a process that consists of audio feature computation, segmentation, feature integration and compression over the segment into audio proto objects that provide a coarse, manageable representation of audio signals that is suited for behavior control. The audio proto objects are then analyzed in different processing stages consisting of e.g. filtering and grouping to define an appropriate behavior.

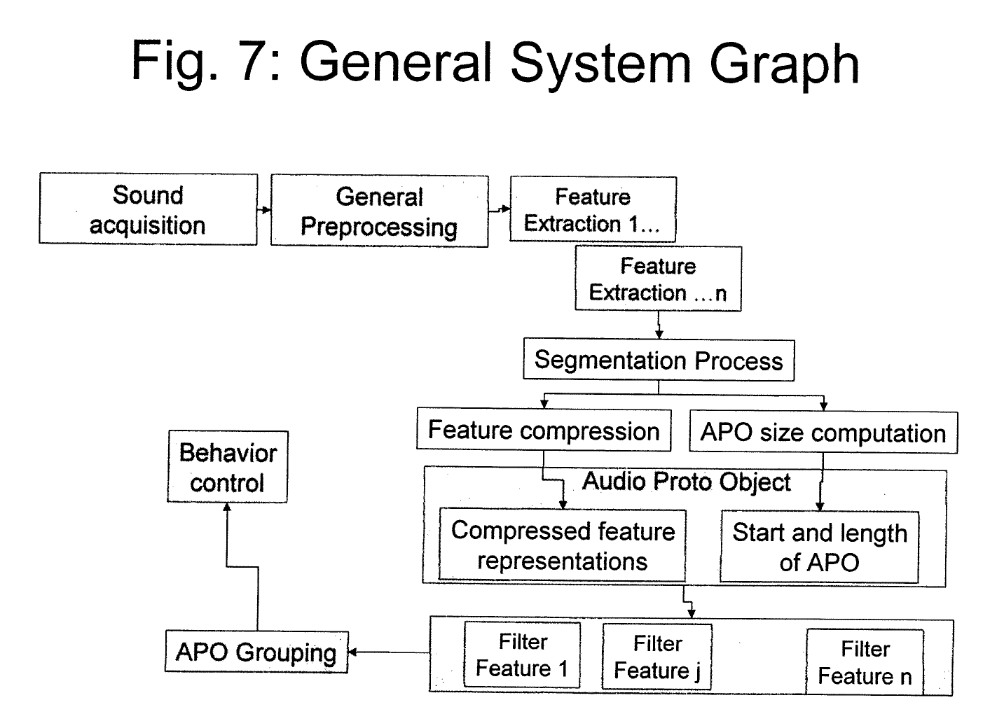

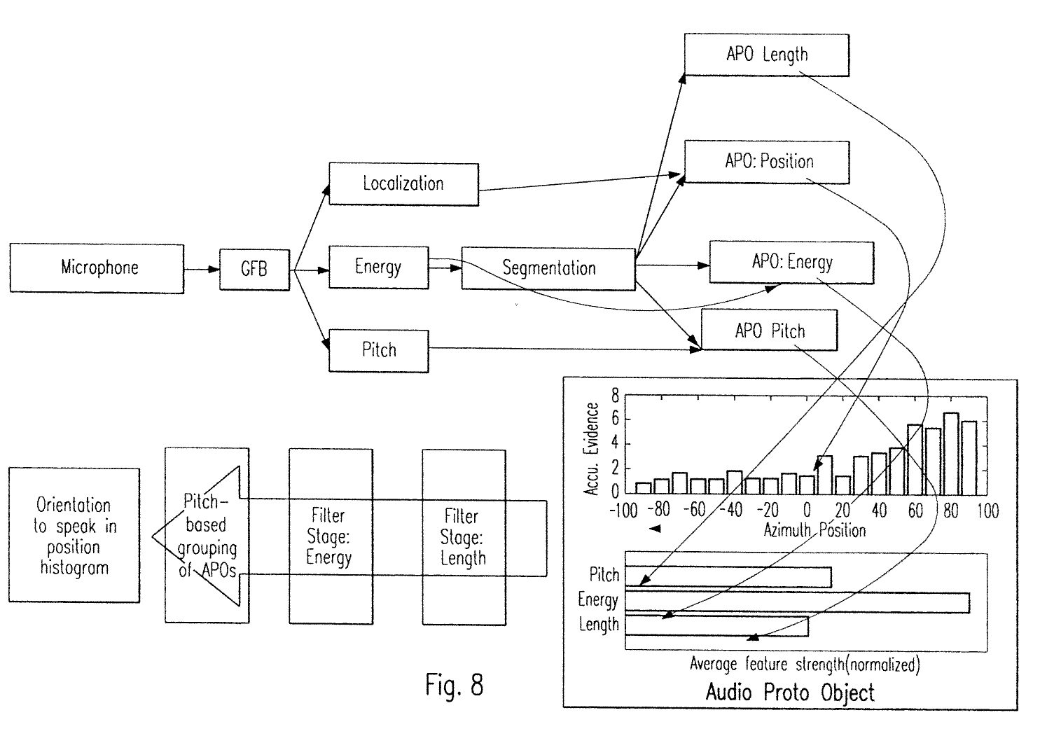

The outline of the proposed system is visualized in FIG. 7. A specific system implementation is depicted in FIG. 8.

### Definition of Audio Proto Object:

An Audio Proto Object (short form: APO) is an entity (i.e. a data object) that contains, as a higher level representation of an audio signal, a collection of condensed audio features for a specific audio segment plus information about the segment itself. A segment is a span in time (when representing in the time domain) or an area in the frequency/time space (i.e. when representing an audio signal in the frequency space. Audio proto objects have a fixed size independent of the size of the original segment and contain information about the audio segment behaviorally relevant for the system processing the audio signals.

### BACKGROUND

This invention is situated in the area of systems for sound processing under real-world conditions [1], e.g. on a robot system. Under these conditions the audio signals recorded by microphones are the sum of many different sound sources and the echoes generated by reflections from walls, ceiling, furniture etc.

The basic, low-level representations of audio signals are unsuited for robotics since it is difficult to directly link audio signals to the proper behavior (“behavior” in the framework being an action or an environmental analysis carried out by e.g. the robot in response to having sensed and processed an audio signal). The invention therefore proposes a method for transforming audio signals into a higher-level representation that is better suited for robotics applications. The proposed system can be implemented, for example, in a robot that is supposed to orient (its head, sensors, movement, . . . ) to relevant audio sources like human speakers.

There are a number of examples for audio sensory signals that are used to direct a robotic system's behavior. The first class of behaviors is a response of the robot to the audio signal by a physical action, such as:
Orientation to a sound source's position.
Entering into a communication with a sound source (a speaker), etc.

The second class of behaviors is a response of the robot to the audio signal by an environmental analysis, which will in turn lead to a modified physical action of the robot in the future:
evaluation of environmental sounds (e.g. collision),
understanding of communication situations (who is communicating with whom).

These scenarios require a number of auditory processing capabilities that go beyond speech recognition or speaker identification, the standard applications of audio processing. These auditory processing capabilities are among others:

sound localization, ignoring behaviorally irrelevant sounds, identifying the sources behind the acquired sounds, analysis of timing and rhythm in dialogue situations.

While speech recognition requires a representation of audio signals that still carries a substantial part of the raw audio information, especially sequence information, many of the above described tasks in robot audition can work sufficiently on more compressed representation of sounds.

### OBJECT OF THE PRESENT INVENTION

It is the object of the present invention to propose a higher level audio signal processing and representation allowing e.g. a robot to adapt its behavior in response to a sensed audio signal.

The proposed solution of the invention comprises audio proto objects according to the invention are using this to provide a smaller representation of audio signals on which behavior selection is easier to perform.

The object is generally achieved by means of the features of the independent claims. The dependent claims develop further the central idea of the present invention.

According to a first aspect of the invention an audio signal processing system comprises:

a) one or more sensors for sensing audio signals,
b.) a module for computing audio signal segments of coherent signal elements,
c.) at least one compressing module for computing a compressed representation of one or more audio features of each audio signal segment, and
d.) a module for storing audio proto objects, which are data objects comprising the compressed representation and the time information of the associated audio signal segment.

Optionally also the time duration of the associated audio signal segment can be stored.

The audio proto objects are preferably designed to all have the same data size independently of the length of the segment represented by the audio proto object.

The system may be designed to group and store in context audio proto objects with similar features.

The segment computing module may perform the segmentation based on at least one of audio cues like signal energy, and grouping areas with homogeneous audio feature values.

The segment computing module may perform the segmentation in the time domain or the spectral domain of the sensed audio signals.

The compressing module(s) may use one or more of the following audio features:

pitch, formants, binaural or spectral localization cues, RASTA features, HIST features, signal energy.

Visual proto objects, generated on the basis of visual sensing, may be stored together with the audio proto objects. Audio and visual features that are common (like position) or linked (like visual size and pitch) can be integrated. Integration means that a mapping can be learned and used that predicts one sensory feature based on input from the other sensory modality. This mapping is likely to be probability-based. The resulting prediction can then be combined with the direct measurement.

A further aspect of the invention relates to a robot, having an audio signal processing system as defined above, wherein the robot further more is provided with a computing unit which controls the robot's behavior based on the stored audio proto objects.

Further advantages, features and objects will become evident for the skilled person when reading the following description of preferred embodiments when taken in conjunction with the figures of the enclosed drawings.

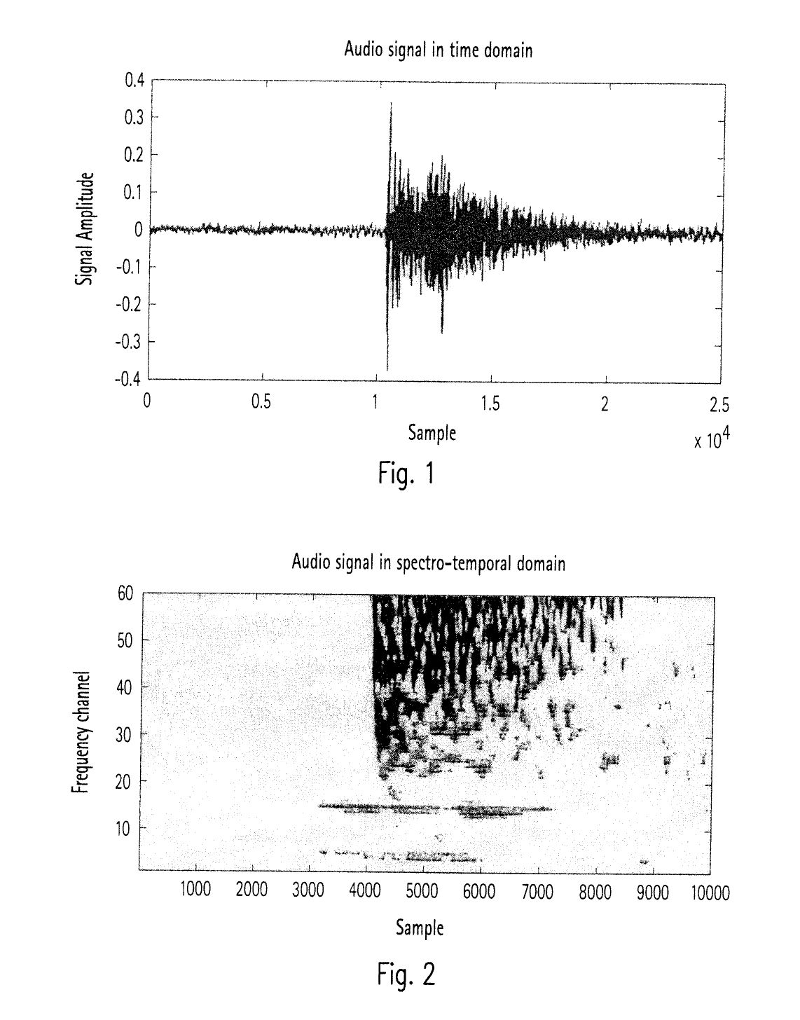

FIG. 1: Audio signal in time domain,

FIG. 2: Audio signal in spectro-temporal domain,

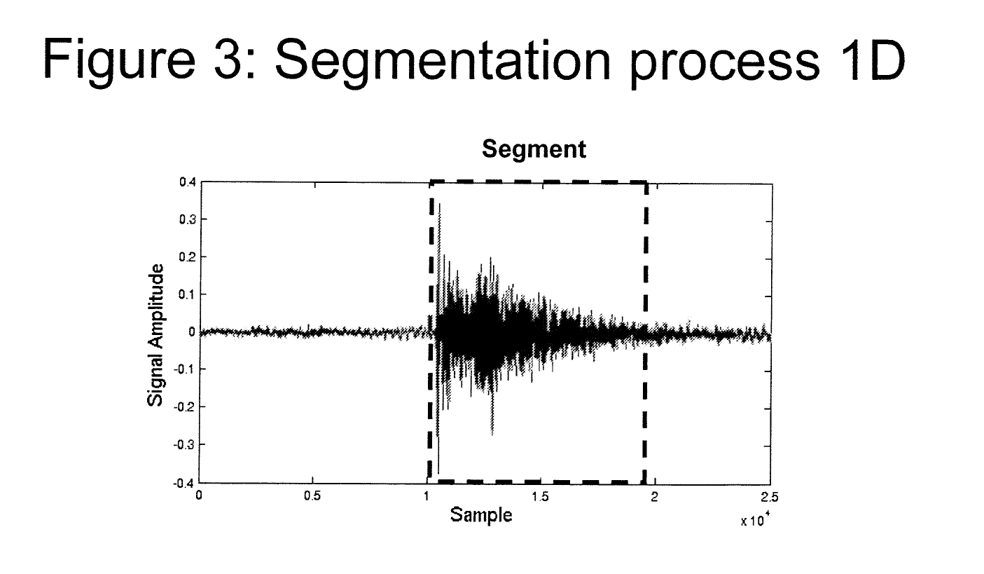

FIG. 3: Segmentation process 1D,

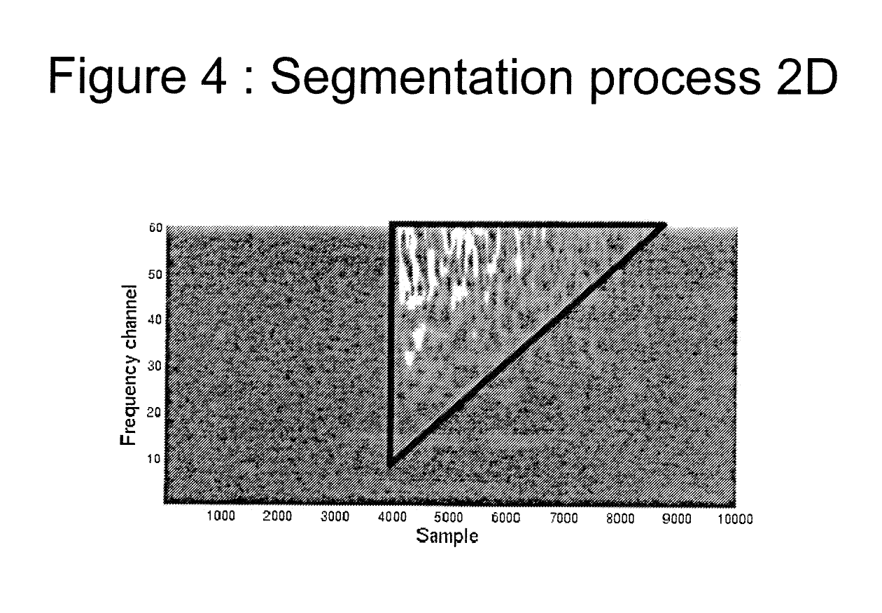

FIG. 4: Segmentation process 2D,

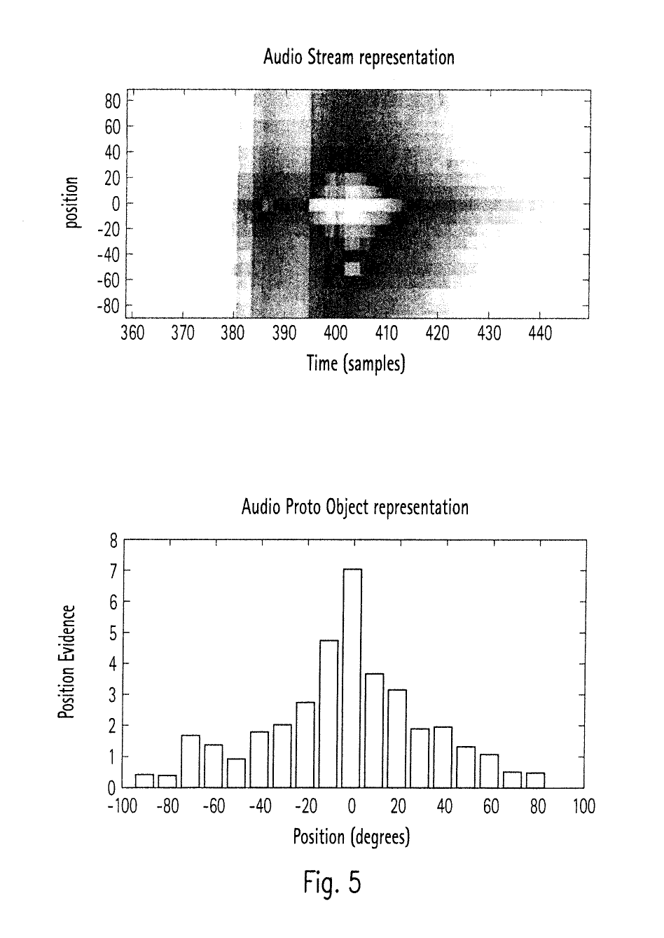

FIG. 5: Position features in Audio Proto Object,

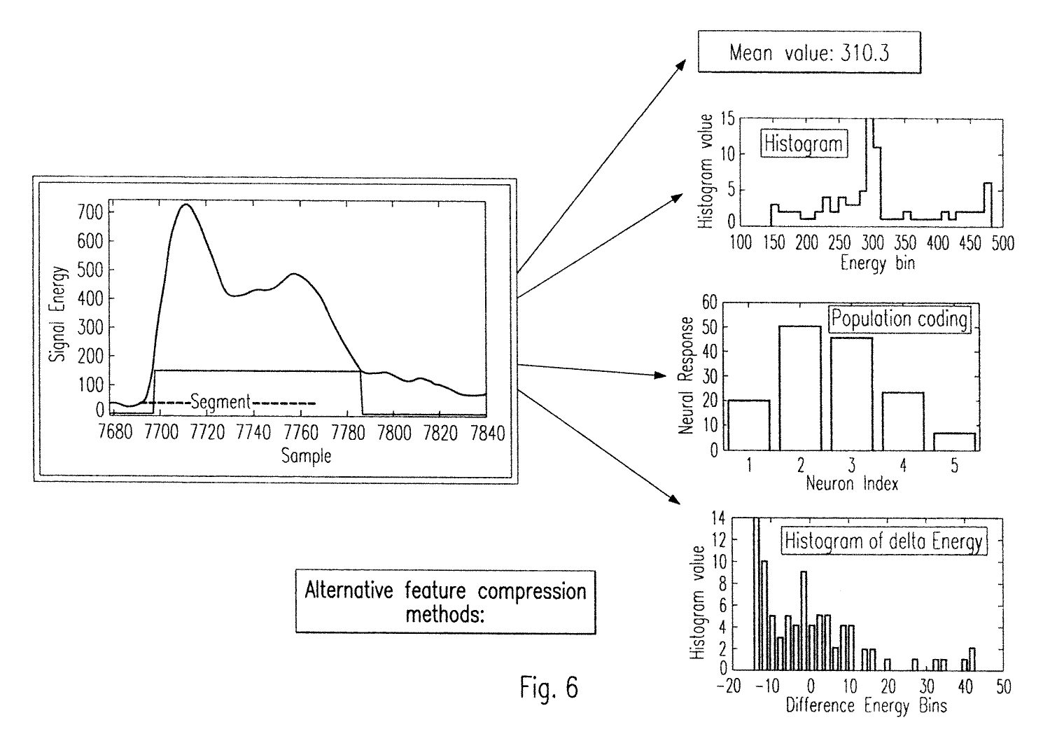

FIG. 6: Signal energy over time in Audio Proto Object—different compression methods,

FIG. 7: Sketch of general system architecture, and

FIG. 8: System graph for sound localization example

FIG. 1 shows an audio signal in time representation. Audio data is generally sensed and then digitally recorded at specific sampling rates, e.g. 16 kHz (see FIG. 1 as an example of a digitally recorded signal). Each measurement will be called a sample in this document. Individual measurements, i.e. single samples, are often too noisy to work on. It is therefore a standard approach to average over many samples to get a stable and reliable result.

Another commonly used approach in audio processing is to perform a frequency analysis of the signal. That means that the 1-dimensional time signal is converted into its frequency components. This is normally done using the standard (Fast) Fourier transformation (FFT or FT), or so called Gammatone Filter Banks (GFBs) [9].

FIG. 2 shows an example of an audio signal in spectro-temporal representation. This figure shows the same signal as in FIG. 1, but after application of a Gammatone Filterbank and envelope extraction. Channel number 1 corresponds to a frequency of 100 Hz, channel 60 to 2000 Hz for an example of an audio signal represented in the frequency/time space.

The benefit of this frequency analysis approach is that some forms of analysis are easier in frequency space. It is also likely that different sources are using different frequency bands, making separation easier in the frequency representation.

Several approaches exist to solve the superposition problem, that is to separate different sound sources in the microphone signal via approaches like Blind Source Separation (BSS) or beam-forming [10].

Bregman [3] presented an approach, called Auditory Scene Analysis (see also [2]), where a collection of audio features (localization features, pitch, formants, signal energy, etc.) is computed and based on these features a separation of signals over time and/or frequency is performed.

FIG. 3 shows a Segmentation process 1D: The segment is defined by looking at signal envelopes in time representation.

The separation of segments is based on either a homogeneity (grouping samples with similar feature values together) or difference analysis (defining borders where feature values change rapidly). The result is a segment, a span in time (for 1D signals, see FIG. 3) or an area in frequency/time space (FIG. 4), which was identified as belonging to the same basic sound element. FIG. 4 shows a segmentation process in 2D: The segment is defined by grouping spectro-temporal elements of similar energy.

This segment is commonly called an auditory stream. Auditory streams are often forwarded to speech recognition modules which require a clear, separated audio signal. Audio streams are still low-level elements, close to the signal level. The description of a stream is the collection of all features in the segment. For segments of different length the feature representations vary in size which makes it difficult to compare audio streams of different size. Furthermore the representation is not well suited for integration with visual input or behavior control, since most of the detailed information in audio streams is unnecessary for behavior control.

The invention proposes to uses audio proto objects as a high-level representation of audio data, the audio proto objects being data objects assembled by assigning compressed and normalized feature values to the segment.

The notation audio proto object (APO) was chosen because not all APOs correspond to semantic objects like syllables, words, or isolated natural sounds like the sound of dripping water. Rather, they will often represent parts or combinations of those sounds.

The features associated with an APO are simple ones like the timing (e.g. start time and length, i.e. the time duration) plus representative values of features for all samples within the segment. Representative values can be generated via a simple averaging process (e.g. arithmetic mean pitch value over all samples), a histogram of values, a population code representation [11], or other methods which provide a fixed length, low-dimensional representation of the segment.

The resulting APO is an easy to use handle to a collection of features that describe the specific audio segment. The APos can be stored over a longer period of time.

### State-of-Art Limitations:

The standard sample-wise processing does not allow an easy integration of single measurements over time or frequency channels because different sample measurements not necessarily belong to the same sound source. Because individual samples show a high variability in their features, the resulting analysis is unreliable. A standard solution is a temporal integration over short periods of time, e.g. via low-pass filtering. This approach is clearly limited especially in scenarios with multiple alternating sound sources or quickly changing features (e.g. position for a moving object).

When audio processing has to be connected to other sensory modalities or behavior control (for example in robotics), different representations are often required. When we consider a typical scenario—sound localization [4]—we see the limits of standard approaches. There will be a continuous estimation of the position of the sound source (to which the robot orients its head to), but the system can't decide how many sources are active and what their audio characteristics are. It is therefore difficult to decide if the current sound is relevant for the robot and there is also the danger that sounds from different sources are merged thereby spoiling sound localization.

### DETAILED DESCRIPTION OF AN EMBODIMENT OF THE PRESENT INVENTION

In an initial stage a segmentation process defines an area in time-frequency space that is considered to result from a common origin or sound source. Segmentation is a standard process that can be based on differences in some audio feature (e.g. changes in estimated position) or homogeneity of feature values over several samples and frequencies. An example of a simple segmentation process is a signal energy-based segmentation (FIG. 3).

All time-frequency elements, grouped together by the segmentation process, form the raw data of the audio proto object. The next is step is a compression of features to a lower-dimensional representation—this can be done e.g. via an averaging of feature values or more advanced methods.

In order to be able to handle and compare audio proto objects, it is proposed that these representations have a fixed size, i.e. the representation of a specific feature has the same dimensionality for all audio proto objects.

The result is a reduced representation of audio features in the segmented time-frequency region (FIGS. 5, 6). FIG. 5 shows localization information in stream and audio proto object form. This figure shows the computed localization information as position evidence for different positions (azimuth angles). The standard approach is depicted on the upper left, where position evidence is computed for every sample, while in the audio proto object concept (lower right) the information is integrated over all samples. For most applications this reduced representation is sufficient to guide behavior and much more condensed.

FIG. 6 shows the signal energy over time for proto object: This figure shows different ways for converting audio features (here signal energy, left plot) to compressed representations. The borders of the segment are marked. The first option for feature compression is a simple mean of energy values over the segment (top right). The second (right, second from top) shows a histogram representation that provides additional information about the distribution of energy values. Similar to the histogram is the representation as a population code (second from bottom, right), which has the added benefit of a variable distribution of bin centers and overlapping responses, i.e. one specific feature value is encoded by several nodes of the population. The bottom plot on the right depicts a representation of derivative feature values. It is the histogram of the temporal derivative of signal energy. In this specific instance it can be seen that there are more samples with a negative energy slope than with a positive one, i.e. the signal energy decays over time.

Example features are segment length, signal energy, position estimation, pitch [4], formants [17], or low-level features like Interaural Time Difference ITD, Interaural Intensity Difference IID [2], RASTA[7], HIST [6] (Hierarchical Spectro-Temporal Features), etc.

Suitable compressed representations of audio features are averaged values over all samples (like mean pitch within a segment, average signal energy) or more extensive methods like feature histograms or population codes [11]. Histograms represent features values in a segment by storing the relative or absolute frequency of occurrence of a certain feature value. Histograms allow a representation of the distribution of feature values in the segment, with the advantage of a fixed length of the representation. Similar to histograms is the concept of population codes that is derived from coding principles in the brain [11]. In this approach a certain feature is encoded by a set of elements (neurons) that respond to a specific feature value each. When different feature values are presented (sequentially or in parallel), they activate different neurons. This allows a representation of many different feature values in a limited set of neurons.

Since these compression methods remove sequence information (the order of feature values is not represented), the invention proposes to include derivative features (first or higher order derivatives in time or frequency) to retain some of the sequence information.

In some cases it can make sense to integrate audio features with an uneven weighting of samples. Since more recent events are often more relevant for behavior than earlier ones we propose to use a leaky integration of audio features. In a leaky integration, the features values for different samples are added up, but activity also decays over time. The result is that the feature response initially increases (almost linearly) so that longer segments produce a higher response. At some point, given constant feature values, the activity saturates. When feature values change over time, the activity is a weighted mean of samples in the segment with a weight that is the lower the further the sample is in the past. This tends to emphasise the role of the final part of the segment. This approach makes sense for example when computing the compressed representation of signal energy (related to loudness), for which it was shown that for human hearing it increases with segment length but saturates after about one second. The higher weighting of the final part of the segment might make sense when analyzing changes in pitch, since the change in pitch near the end of a phrase is an important cue for determining whether the phrase is a question or a statement. For a feature f the leaky integration to compute the compressed feature P can be performed iteratively as:

P(t)=α*P(t−1)+(1−α)*f(t); P(t0)=0

The desired compressed feature value is P(t=t₁), where t₁ is the end of the segment. The process is initiated with P(t=t₀)=0 and starts at the beginning of the segment (at t=t₀). The parameter α defines the time constant of temporal integration.

When auditory signals have been transformed into auditory proto objects the further handling of these signals becomes easier. As an example take the orientation of a robot's head towards the sound source. Assuming that sound source position is one of the extracted features in the proto object, the audio proto objects are a suitable representation of audio data for behavior or motor control. In certain situations it is desired to limit orienting motions of the robot to certain types of audio signals (e.g. only respond to speech or signals with a minimum length). Then compressed feature values in the audio proto objects often provide the necessary information to decide if the specific signal is to be attended to or not. In some cases a simple threshold filtering (e.g. length>threshold) is sufficient to select relevant APOs, in other cases the full set of proto object features has to be analyzed to make the decision.

Since APOs have a compressed feature representation, many APOs can be kept in memory. Therefore audio proto objects are a natural building block of audio scene memories. It is also possible to compare and combine different audio proto objects in scene memory when their features (e.g. timing) indicate a common sound source. Based on this grouping of APOs it is possible to determine sequences and rhythms of these proto objects or sound sources, which can act as additional audio features.

In vision, a similar concept of visual proto objects was recently proposed [8, 16], based on psychological data [13, 14, 15]. While segmentation processes and features are different, there exists a possibility to have a simple integration of visual and audio proto objects. The position of a sound generating object is the same in the audio and visual domain. Therefore it is a common approach in the literature to combine the two modalities [12], albeit no proto object concept is used. Since the integration operates on a rather low-level (raw position estimations in both modalities) it is a substantial problem to know if for a given pair of audio and visual signal there is a common source. The proto object concept provides a solution to this problem: It is possible to learn the relation between visual and audio features. Then, if those features match for a pair of proto objects, the proto objects can be assigned to the same source and the localization estimation of the two proto objects can be integrated.

Based on the audio proto object concept it is also possible to measure audio features and then predict the features of the visual proto object (‘search for an object that could have generated this sound’).

With the audio proto object concept it is possible, assuming a correct segmentation, to separate different sound sources, extract their characteristics like position or mean pitch, and react to the sound depending on its features. We could, for example, analyze the audio proto object's mean pitch and if it is in the correct range, orient the head towards the measured position (which is also stored in the proto object).

When one looks at the timing of audio proto objects and groups of similar proto objects (those which likely result from the same source) a rhythm of timing might appear. Computing this rhythm allows the prediction of the next occurrence of a proto object. In a slight modification we can also analyze the timing of consecutive proto objects from different sources (e.g. in a dialogue) and predict which audio source is going to be active next and when. The prediction can support feature measurements and later grouping processes.

Measuring deviations from those predictions can be used to detect changes in the scene, e.g. when a communication between two people is extended to a three-people communication and therefore speaker rhythms change.

### Difference to Bregman's Concept of Audio Streams:

In contrast to Bregman's audio streams which are designed to provide perfectly separated audio signals still containing the full detailed information the invention proposes to condense the information to a level that can be handled in robotics applications, especially for behavior selection.

Audio proto objects are smaller and of fixed size, thus allowing a direct comparison of different audio proto objects. We propose to use the audio proto objects as basic elements of a scene representation, and for interaction with other modalities like vision.

Summary: —APOs use compressed feature values
—APOs have a fixed size independent of segment size

### Difference to Concepts of Visual Proto Objects:

Visual proto objects are similar in their target—to generate a compact, intermediate representation for action selection and scene representation. The segmentation process and the features are however totally different. The proposed concepts for visual proto objects also contain a very low-level representation comparable to Bregman's audio streams.

FIG. 7 shows schematically a system graph for audio proto objects-based behavior selection. After sound acquisition (e.g. using a set of microphones) and an optional general preprocessing stage (e.g. to use a GFB) a number of n audio features are computed. Using one or more audio features the segmentation process is applied which provides segment borders.

Based on the segment information compressed representations for all audio features are computed. A variety of methods can be used, even different methods for different cues are possible. The basic requirement is that the compressed features have a size that is invariant of the segment. In addition to compressed feature values, additional timing information is computed (start and stop time of segment, or start time and length). The previous processing stage defines the audio proto objects. Next, a number of filtering modules is applied that analyses audio proto object features individually or in combination to decide if audio proto objects are passed on. After the filtering modules there is an optional stage that can group different proto objects with similar values together. Finally, behavior selection evaluates the remaining audio proto objects and performs a corresponding action.

### Example of an Implementation:

FIG. 8 shows schematically the signal processing flow in a selective sound localization with audio proto objects, thus giving an example of an application of the audio proto object system for selective orientation to the position of a sound source.

After sound acquisition a Gammatone Filterbank is applied. The resulting signal is used to compute signal energy, pitch, and position estimation. The signal energy was chosen to define segment borders. Here a simple approach is chosen: the segment starts when the energy exceeds a specific threshold and ends then energy falls below the threshold.

Then the length of the segment (difference between start and end time of the audio proto object), the arithmetic mean of pitch and signal energy, and the accumulated evidence for all positions are computed. The result is an audio proto object, an example of which is depicted in the lower right corner. Two filtering modules only pass on audio proto objects, for which length and mean energy exceed a defined threshold.

In an optional step audio proto objects with a similar mean pitch can be grouped and their feature values averaged. Finally, the system (e.g. a robot) will orient towards the position of the sound source, by searching for the position with the highest evidence (80 deg in the example) and turn its head (being provided with sensors) towards this position.

In FIG. 8 one specific realization of the audio proto object system is visualized. Sound signals are recorded using one or more microphones (at least for sound localization). Afterwards, a Gammatone Filterbank (GFB) is used to perform a frequency decomposition of the signal. Based on the resulting signal a number of processing modules are fed. The sound localization module analyses the signals from at least two microphones and provides sample-wise position estimations in the form of evidence values for certain positions (here the frontal horizontal range between 90 and −90 degrees azimuth angle is used, resulting in a diagram as shown in the lower graph of FIG. 5). Also based on the GFB signal the signal's pitch is computed. Also based on either the GFB or the raw microphone signal the sample-wise signal energy is computed.

The energy is used as the segmentation cue, i.e. the segmentation is performed based on the energy per sample computation. A segment (time span segment in this example) is started (at time t₀) when a pre-specified energy start-threshold Θₛₜₐᵣₜ is exceeded and ends (at time t₁) when the energy falls below the stop-threshold Θₛₜₒₚ. Note that the two threshold values can be chosen identically. The length (time duration) of the audio proto object is computed as the time (or number of samples) between start and stop of the segment (L=t₁−t₀).

The audio proto object is now initiated and feature values are averaged over the full segment. The length of the APO, the mean energy and mean pitch over all samples in the segment are computed, and then the position evidence for all positions during the whole segment are added up. The resulting values are stored in the audio proto object.

Then the audio proto objects are processed in a number of filtering stages, where proto object values are analyzed and only those audio proto objects with the correct values (i.e. values exceeding threshold values of preset criteria) are passed to the next processing stage. As a specific example all audio proto objects are discarded which are not long and loud (i.e. high energy) enough. In many real-world scenarios this can for example be used to filter out background noise and short environmental sounds like mouse-clicks.

The remaining validated proto objects can now be assigned to different sound sources (e.g. speakers) depending on their position and their pitch. If all audio proto objects with a similar position and pitch are averaged, the system can get an improved estimation of position and mean pitch of different sound sources (e.g. a male and female speaker at different positions). Finally the system can decide to orient to one of the audio proto objects stored in a memory, e.g. by searching for one with a specific pitch and using the integrated position estimation to guide the robot's motions.

1. An audio signal processing system, comprising:
a.) one or more sensors for sensing audio signals,
b.) a module for computing audio signal segments of coherent signal elements,
c.) at least one compressing module for computing a compressed representation of one or preferably more audio features of each audio signal segment, and
d.) a module for storing audio proto objects, which are data objects comprising the compressed representation and time information, especially the starting time and/or the time duration of the associated audio signal segment.

2. The system according to claim 1, wherein the audio proto objects are designed to all have the same data size independently of the length of the segment represented by the audio proto object.

3. The system according to claim 1, wherein the system is designed to group and store in context audio proto objects with similar features.

4. The system according to claim 1, wherein the segment computing module performs the segmentation based on at least one of audio cues like signal energy, and grouping areas with homogeneous audio feature values.

5. The system of claim 4, wherein the start, end, or center of gravity positions of different audio proto objects is stored and set in relation to each other in order to predict the next occurrence of an audio proto object.

6. The system according to claim 1, wherein the segment computing module performs the segmentation in the time domain or the spectral domain of the sensed audio signals.

7. The system according to claim 1, wherein the compressing module(s) use one or more of the following audio features: pitch, formants, binaural or spectral localization cues, RASTA features, HIST features, signal energy.

8. The system according to claim 1, wherein the compressing module(s) use one or more of the following compression techniques: preferably arithmetic mean values, histogram representations, or activations in cluster centers similar to a neural population code.

9. The system according to claim 8, wherein the compressing module(s) use in addition to standard feature values, also temporal or spectral derivative values of first or higher order.

10. The system according to claim 1, wherein the compressing module(s) is designed to perform an integration of said audio features over time via a leaky integration so that the response, i.e. the accumulated audio feature values, increases over time and later samples of the segment have a higher influence on the compressed features in the audio proto object than earlier samples.

11. The system according to claim 1, wherein visual proto objects, generated on the basis of visual sensing, are stored together with the audio proto objects.

12. A robot, having an audio signal processing system according to claim 1, wherein the robot further more is provided with a computing unit which controls the robot's behavior based on the stored audio proto objects.

13. The robot according to claim 12, where the robot's behavior is controlled depending on the values of individual features or their combinations of the audio proto objects.

14. An audio signal processing method, comprising the steps of:
a.) sensing and digitally recording audio signals,
b.) computing audio signal segments of coherent signal elements out of the recorded audio signals,
c.) computing a compressed representation of audio features of each audio signal segment, and
e.) storing audio proto objects, which are data objects comprising the compressed representation and time information, i.e. the starting time and/or the time duration of the associated audio signal segment.

15. A computer software program product, executing a method according to claim 14 when running on a computing device.
